(19) United States
(12) Patent Application Publication
(10) Pub. No.: US 2026/0015824 A1
(43) Pub. Date: Jan. 15, 2026

(54) A Method Of Operating A Work Vehicle According To A Maximum Allowable Swing Speed

(71) Applicant: Caterpillar SARL, Geneva (CH)

(72) Inventors: Chris Cesur, Akashi-shi, Hyogo (JP); Sei Shimahara, Akashi-shi, Hyogo (JP); Shogo Tada, Akashi-shi, Hyogo (JP); Shuji Tokuda, Akashi-shi, Hyogo (JP); Mitsuhiro Toyoda, Akashi-shi, Hyogo (JP)

(21) Appl. No.: 19/141,287

(22) PCT Filed: Dec. 18, 2023
(86) PCT No.: PCT/EP2023/025535

§ 371 Date: Jun. 19, 2025

(30) Foreign Application Priority Data
Dec. 23, 2022 (GB) 2219627.3

(51) Int. Cl. E02F 9/12; E02F 9/26

(52) U.S. Cl. CPC E02F 9/123; E02F 9/265

(57) ABSTRACT

PURPOSE: To control crane operation in safety and high working efficiency by limiting upper limit value of swing angle speed automatically, corresponding to a working radius calculated from the length and angle of a boom and a load factor of a crane. CONSTITUTION: A working radius R is searched from a boom angle beta and a boom length L detected with detectors 1, 2, with a computing element 3, and an allowable maximum swing angle speed omegamax is computed by a first function generating means 7. Meanwhile, from a cane load W detected with a detector 4, working radius R, and boom length L, a rated value Wa with a computing element 5, moreover a load factor P with a dividing apparatus 6 are searched, and a decreasing factor of swing angle speed K is calculated with a second function generating means 8. omegamax.K is searched with a multiplicator 9, and output as a control signal which sets it as the upper limit value of swing angle speed, to a swing driving mechanism A. Hereby, the swing angle speed corresponding to various working radii and load factors are obtained. The maximum swing angle speed is limited according to the working condition, and controlling of crane operation can be performed in safety and high working efficiency.

### TECHNICAL FIELD

The present disclosure relates to a method of operating a work vehicle according to a maximum allowable swing speed, a controller configured to perform such a method and a work vehicle configured to be operated in accordance with such a method.

### BACKGROUND

Work vehicles or machines such as excavators or backhoe loaders have various degrees of freedom. One such degree of freedom is swing, which refers to the rotation of the main body relative to its undercarriage, or the rotation of an arm arrangement relative to the main body. Various features affect the swing characteristics, including the swing speed and swing acceleration of the work vehicle. For example, the position of its components, such as the position of an arm arrangement and/or tool, may alter a moment of inertia. This may affect the rate at which the swing speed can be increased or decreased. In addition, a configuration of the work vehicle, such as the type of tool attached, may affect the moment of inertia and therefore the rate at which the swing speed can be increased or decreased.

It is important that the swing speed can be reduced to zero within a certain distance or time to allow an operator to stop the swing quickly, such as when becoming aware of an obstruction or hazard within a safe distance.

In addition to this general requirement, European regulation EN 474 requires that a work vehicle, specifically an excavator, must be able to stop from full speed within a safe distance. The regulation previously required that this be accomplished with the most common configuration of the work vehicle. The European regulation EN 474 has been updated to require that a work vehicle must be able to stop within the safe distance in every available configuration.

### SUMMARY

An object of the present disclosure may be to provide a method of limiting the maximum operational swing speed of a work vehicle for allowing the work vehicle to reduce its swing speed to zero in a safe distance. A further object is to ensure that such a method operates across the different authorised configurations of the work vehicle. In addition, a further object is to ensure that such a method does not overly reduce the swing speed of the work vehicle. If the swing speed is overly reduced, an operator may notice this during single function and some multi-function operations.

The present disclosure is generally directed towards limiting the maximum operational swing speed of a swing apparatus of a work vehicle, such as the main body and arm arrangement of an excavator, so that it can stop within a safe distance and/or angle.

Data regarding an extension of an arm arrangement can give an indication of the moment of inertia of the work vehicle for its current arm position. Arm position data is therefore used to directly determine an appropriate maximum swing speed of the swing apparatus so that it can stop within a safe distance. A map links the arm position data to the maximum swing speed used to limit the maximum operational swing speed of the swing apparatus.

The present disclosure provides a method of operating a work vehicle comprising a swing apparatus rotatable about a swing axis. The swing apparatus comprises an arm arrangement comprising a stick and a boom. The work vehicle further comprises at least one arm position sensor mounted to the swing apparatus for generating arm position data indicative of a position of the stick and/or the boom. The method comprises, by a control system, determining a maximum allowable swing speed of the swing apparatus rotating about the swing axis, to account for the moment of inertia of the swing apparatus, based on arm position data, and a map linking arm position data with the maximum allowable swing speed. The method further comprises limiting a maximum operational swing speed of the swing apparatus to the maximum allowable swing speed.

There is also provided a controller for controlling a work vehicle comprising a swing apparatus rotatable about a swing axis. The swing apparatus comprises an arm arrangement comprising a stick and a boom. The work vehicle further comprises at least one arm position sensor mounted to the swing apparatus for generating arm position data indicative of a position of the stick and/or the boom. The controller is configured to determine a maximum allowable swing speed of the swing apparatus rotating about the swing axis, to account for the moment of inertia of the swing apparatus, based on arm position data, and a map linking arm position data with the maximum allowable swing speed. The controller is further configured to limit a maximum operational swing speed of the swing apparatus to the maximum allowable swing speed.

There is also provided a work vehicle comprising a swing apparatus rotatable about a swing axis. The swing apparatus comprises an arm arrangement comprising a stick and a boom. The work vehicle further comprises at least one arm position sensor mounted to the swing apparatus for generating arm position data indicative of a position of the stick and/or the boom, and a control system comprising the controller described above.

By way of example only, embodiments according to the present disclosure are now described with reference to, and as shown in, the accompanying drawings.

### BRIEF DESCRIPTION OF THE DRAWINGS

FIG. 1 is a side elevation of an embodiment of a system of the present disclosure;

FIG. 2 is a top elevation of the system of FIG. 1;

FIG. 3 is a schematic of a control system of the system of FIG. 1;

FIG. 4 is a flowchart illustrating a method of operating the work vehicle of the present disclosure;

FIG. 5 is a schematic graph illustrating a maximum allowable swing speed as a stick angle and boom angle of the work vehicle of the present disclosure vary; and

FIG. 6 is a schematic graph illustrating a maximum allowable swing speed as an extension of an arm arrangement of the work vehicle of the present disclosure varies.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention, it being understood that various changes may be made in the function and arrangement of elements, including combinations of features from different embodiments, without departing from the scope of the invention. Specific details are given in the following description to provide a thorough understanding of the embodiments. However, it will be understood by one of ordinary skill in the art that embodiments may be practised without these specific details. For example, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to, portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

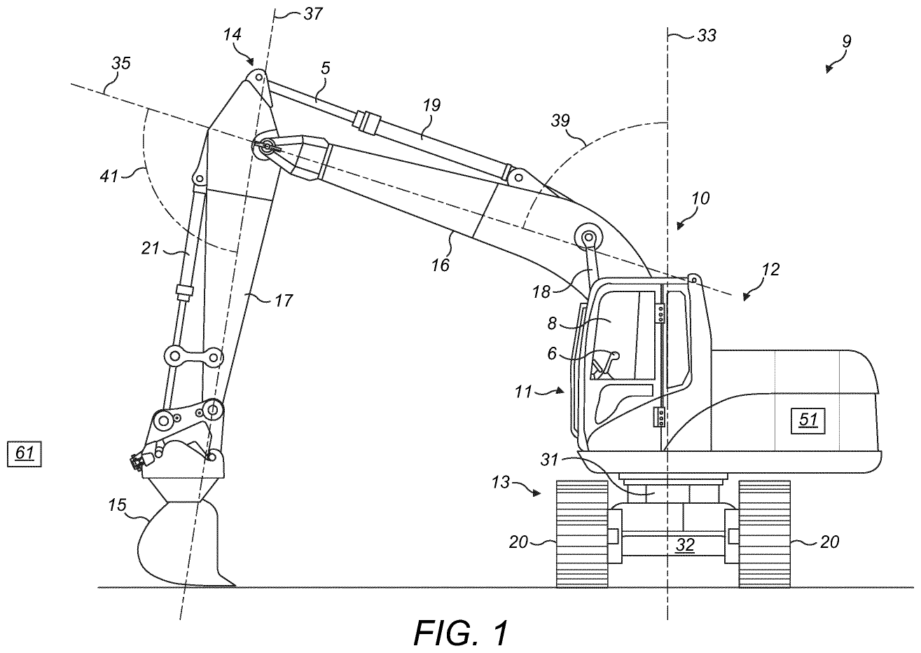

FIG. 1 illustrates an embodiment of a system 9 comprising a work vehicle 10, in this case an excavator. The work vehicle 10 may be any suitable type of work vehicle 10, including multi-purpose work vehicles, such as excavators, backhoes, loaders, dozers, shovels, fellers, harvesters, material handlers and other such work vehicles. The work vehicle 10 comprises a swing apparatus 11 and may comprise a swing base 13. The swing apparatus 11 comprises an arm arrangement 14. The swing apparatus 11 may comprise a main body 12. The swing base 13 may comprise an undercarriage 32 and/or a platform. The undercarriage 32 may comprise wheels or tracks 20. The main body 12 may comprise a cab 8 for an operator and a power unit (not shown) therein for providing power to the wheels or tracks 20.

The swing apparatus 11 may be attached to the swing base 13 via a swivel mount 31. The swivel mount 31 may allow the swing apparatus 11 to rotate in relation to the swing base 13. The swivel mount 31 may comprise a slip ring or a slewing ring. Rotation of the swing apparatus 11 relative to the swing base 13 may be actuated using a swing actuator 30. The swing actuator 30 may comprise a hydraulic motor or a hydraulic swivel.

The swing apparatus 11 is rotatable about a swing axis 33. The swing apparatus 11 may be able to rotate by 360 degrees relative to the swing base 13 about the swivel mount 31 and/or swing axis 33. The swing axis 33 may be perpendicular to the swing base 13 and/or may be perpendicular to a horizontal plane or the ground when the work vehicle 10 is on a level surface. The swing axis 33 may be a central axis of the swivel mount 31 and may be the axis of rotation of the swing apparatus 11 relative to the swing base 13 at the swivel mount 31.

The arm arrangement 14 comprises a boom 16 and a stick 17. The boom 16 and the stick 17 may be pivotally attached to one another. The boom 16 may be pivotally attached to the main body 12 at a first end of the boom 16. The stick 17 may be pivotably attached to the boom 16 at a second end of the boom 16 and a first end of the stick 17. A tool 15 may be connected to the arm arrangement 14. The tool 15 may be pivotably attached to the stick 17 at a second end of the stick 17. The arm arrangement 14 may comprise at least one hydraulic actuator 18, 19, 21 for controlling the orientation thereof. In particular, the arm arrangement 14 may comprise the boom hydraulic actuator 18 for controlling the orientation and movement of the boom 16. The arm arrangement 14 may comprise a stick hydraulic actuator 19 for controlling the orientation and movement of the stick 17. The arm arrangement 14 may comprise a tool hydraulic actuator 21 for controlling the orientation and movement of the tool 15.

The tool 15 may be of any suitable type. The tool 15 may, for example, be a bucket as illustrated or may be a grapple, tiltable bucket, tilt rotator, hammer, handling arm, multi-processor, pulveriser, saw, shears, blower, grinder, tiller, trencher, winch, auger, broom, cutter, planer, delimber, felling head, mulcher, or rake. The tool 15 may comprise a spray head or the like for providing a water spray during operation of the work vehicle 10, for example for dust suppression. The fluid may be pressurised hydraulic fluid, water or the like.

The work vehicle 10 may be operable in, configurable in and/or comprise at least one configuration. The configuration may refer to one or more of a swing apparatus 11 measurement; a swing base 13 measurement; a boom 16 measurement; a stick 17 measurement; a main body 12 measurement; a cab 8 measurement; a tool 15 measurement; and/or a type of tool 15. The aforementioned measurements may be a dimension measurement and/or a weight measurement. The dimension measurement may be a length, a width, a depth, an area, and/or a volume. The weight measurement may be a weight or a mass.

The work vehicle 10 may be operable in, configurable in, and/or comprise a plurality of configurations with different inertias, including a configuration having the greatest moment of inertia. In the greatest inertia configuration, the type of tool 15 may be a tool with a greater mass than other available tools and/or the arm arrangement 14 may comprise components of a greater length, weight and/or mass.

The work vehicle 10 and arm arrangement 14 may be orientable in and/or comprise an arm position. The arm position may comprise a boom 16 position; a stick 17 position; and/or a tool 15 position. The position may be defined by a component angle. The position may be defined by a component cylinder extension. The arm position may comprise an arm arrangement 14 position, a component position or a linkage position. Each configuration of the work vehicle 10 may be capable of having a plurality of different arm positions.

The boom 16 may comprise a boom axis 35. The boom axis 35 may be an axis parallel to the direction along which the boom 16 extends for a majority of its length. The stick 17 may comprise a stick axis 37. The stick axis 37 may be an axis parallel to the direction along which the stick 17 extends for a majority of its length. A boom angle 39 may be the angle between the boom axis 35 and the swing axis 33. A stick angle 41 may be the angle between the boom axis 35 and the stick axis 37. The boom angle 39 and/or stick angle 41 may be used to define the arm position. Global angles wherein the various axes are measured relative to the horizontal may be used to define the arm position.

The boom, stick and tool hydraulic actuators 18, 19, 21 may each comprise a hydraulic cylinder and a piston rod. Hydraulic fluid may be supplied to the actuators to displace the rod relative to the cylinder. The boom hydraulic actuator 18 may comprise a boom hydraulic piston rod (not shown). The stick hydraulic actuator 19 may comprise a stick hydraulic piston rod 5. As the stick hydraulic piston rod and/or the stick hydraulic piston rod 5 are extended, the arm position may change. A boom hydraulic piston rod extension and/or a stick hydraulic piston rod extension may be used to define the arm position.

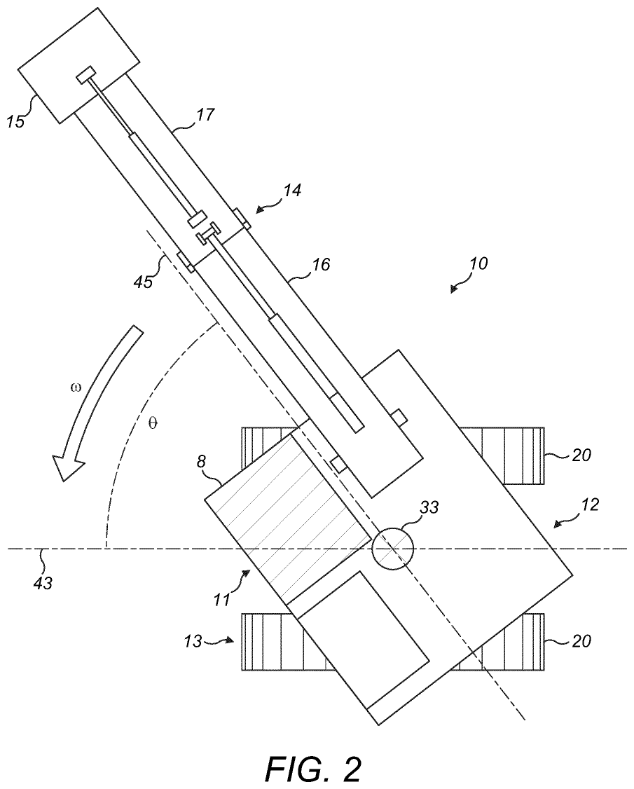

FIG. 2 provides an illustration of the work vehicle 10 of FIG. 1 in plan view, in which the swing axis 33 is illustrated as a point. The work vehicle may comprise a reference travel axis 43. The reference travel axis 43 may be substantially horizontal to the ground 33, lie in the same plane as the horizontal, and may pass through and/or be perpendicular to the swing axis 33. The reference travel axis 43 may be parallel to the direction the work vehicle travels when the tracks 20 are actuated simultaneously with the same input. The reference travel axis 43 may be parallel to a direction the work vehicle 10 travels when a forward command is given.

The work vehicle 10 may comprise a swing apparatus axis 45. The swing apparatus axis 45 may lie in the same plane as the horizontal, and/or may lie in the same plane as the reference travel axis 43. The swing apparatus axis 45 may be parallel to a direction of extension of the arm arrangement 14 (as shown in FIG. 2) and may pass through and/or be perpendicular to the swing axis 33. The swing apparatus axis 45 may be parallel to a direction an operator faces while sitting in the cab 8.

The work vehicle 10 may comprise a swing angle θ. The swing angle θ may be defined as the angle measured between the reference travel axis 43 and the swing apparatus axis 45. When the swing angle θ is increased or decreased, the swing apparatus 11 may rotate around the swing axis 33 at a swing speed ω. The swing apparatus 11 may rotate relative to the swing base 13 at a swing speed ω. The swing apparatus 11 may rotate around the swing axis 33 in a swing direction (clockwise or anti clockwise). The swing speed ω may be a swing velocity comprising the swing direction.

The work vehicle 10 may comprise a work vehicle fluid circuit (not shown) around which fluid may be circulated. The work vehicle 10 may comprise a controller 51 for controlling the work vehicle fluid circuit automatically or based upon inputs received from at least one input device 6 (shown in FIG. 1). The at least one input device 6 may comprise one or more of a joystick, a display 57, a touch screen, a button, or any suitable input device. The least one input device 6 may be used to operate the work vehicle 10. The work vehicle 10 may be operated to change the arm position. The work vehicle fluid circuit may be connected to the at least one hydraulic actuator 18, 19, 21. Changing the arm position may comprise controlling the at least one hydraulic actuator 18, 19, 21 for pivoting of the arm arrangement 14 and the tool 15. The work vehicle 10 may be operated to increase or decrease the swing angle θ. The work vehicle fluid circuit may be connected to the swing actuator 30 and a swing brake 34 for controlling the swing of the swing apparatus 11 relative to the swing base 13.

The swing speed ω may be controlled and/or affected by the least one input device 6. When an input to the least one input device 6 indicates an increase, the swing speed ω may increase. When the input to the input device 6 indicates a decrease, the swing speed ω may decrease. When an input of 100% speed is provided to the at least one input device 6, the swing speed ω may increase towards a maximum operational swing speed of the work vehicle. When an input of 0% speed is provided to the at least one input device, the swing speed ω may decrease towards a zero swing speed ω, or the swing speed ω may remain at zero.

In order to decrease the swing speed ω, the system 9 may apply the swing brake 34 and/or may stop the application of torque by the swing actuator 30. The system 9 may apply the swing brake 34 to the swivel mount 31 and/or the swing actuator 30. The swing brake 34 may apply a brake torque τ_{b} in the opposite direction to the swing direction. The swing brake 34 may cause the swing speed ω to decrease. The swing brake 34 may cause the swing speed ω to decrease to zero.

For reasons of safety, it may be beneficial that the system 9 is able to reduce the swing speed ω to zero within a predetermined maximum angular stopping displacement θₛ. In addition, there are regulatory requirements that the system 9 is able to reduce the swing speed ω to zero within the predetermined maximum angular stopping displacement θₛ. The predetermined maximum angular stopping displacement θₛ may be a 90-degree angular displacement. It may be required that the system 9 is able to reduce the swing speed ω to zero from the maximum operational swing speed within a predetermined angular displacement. It may be required that the system 9 is able to reduce the swing speed ω to zero from the maximum operational swing speed within an angular displacement of 90 degrees. It may be required that the system 9 is able to reduce the swing speed ω to zero within the predetermined maximum angular stopping displacement θₛ regardless of the configuration and/or arm position of the work vehicle 10. Instead of the predetermined maximum angular stopping displacement θₛ, a different metric, such as a predetermined maximum stopping time, may be used.

The swing apparatus 11 comprises a moment of inertia J. The moment of inertia J is the physical quantity of a body which represents the body's resistance to a change in angular speed. The moment of inertia J affects the ability of the system 9 to reduce the swing speed ω to zero within the predetermined maximum angular stopping displacement θₛ. A larger moment of inertia/results in a larger angular displacement required to reduce the swing speed ω to zero and results in a lower swing speed being required to so that the swing speed ω can be reduced to zero within the predetermined maximum angular stopping displacement θₛ.

The moment of inertia J may be linked to the brake torque τ_{b} and an angular deceleration experienced during braking by the following formula:

$${τ}_{b} = J α$$

Where α is the angular deceleration and is the rate of change of swing speed ω.

The moment of inertia J around an axis, may be defined as the sum of the products obtained by multiplying the mass of each particle of matter in a given body by the square of its distance from the axis. The moment of inertia J of the swing apparatus 11 may be higher when a tool 15 with a larger mass is attached to the arm arrangement 14 and may be lower when a tool 15 with a smaller mass is attached to the arm arrangement 14. The moment of inertia J of the swing apparatus 11 may be higher when the arm position is such that the arm arrangement 14 extends by a longer distance from the swing axis 33 and may be lower when the arm position is such that the arm arrangement 14 extends by a shorter distance from the swing axis 33. The moment of inertia J may constantly change when the work vehicle 10 is in use and is therefore not a known design parameter of the work vehicle 10.

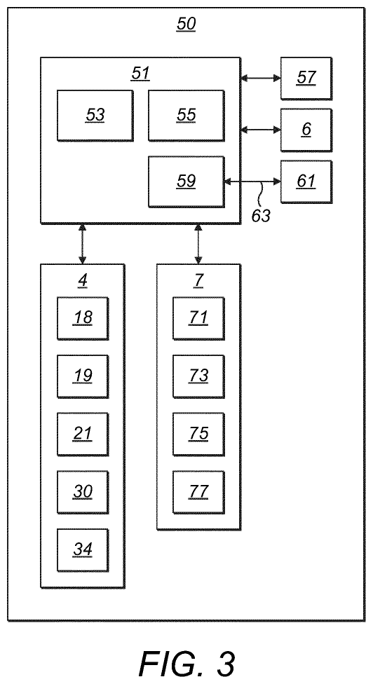

The system 9 may comprise a control system 50, which may be configured to perform the methods of the present disclosure. As illustrated in FIG. 3, the control system 50 may comprise the controller 51, which may comprise a memory 53, which may store instructions or algorithms in the form of data, and a processing unit 55, which may be configured to perform operations based upon the instructions. The controller 51 may be of any suitable known type and may comprise an engine control unit (ECU) or the like. The memory 53 may comprise any suitable computer-accessible or non-transitory storage medium for storing computer program instructions, such as RAM, SDRAM, DDR SDRAM, RDRAM, SRAM, ROM, magnetic media, optical media and the like. The processing unit 55 may comprise any suitable processor capable of executing memory-stored instructions, such as a microprocessor, uniprocessor, a multiprocessor and the like. The controller 51 may further comprise a graphics processing unit for rendering objects for viewing on the display 57 of the control system 50. The controller 51 may also be in communication with least one work vehicle communication module 59 for transferring data with an external computing system 61 via a wired or wireless network 63 (such as Ethernet, fibre optic, satellite communication network, broadband communication network, cellular, Bluetooth). The external computing system 61 may comprise computing systems, processors, servers, memories, databases, control systems and the like.

As summarised in FIG. 3, the system 9 may comprise at least one system actuator 4. The at least one system actuator 4 may comprise one or more of the boom, stick and tool hydraulic actuators 18, 19, 21, the swing actuator 30 and the swing brake 34.

The system 9 comprises at least one arm position sensor 75. The at least one arm position sensor 75 is mounted to the swing apparatus 11. The at least one arm position sensor 75 is for generating arm position data indicative of a position of the stick 17 and/or boom 16. The at least one arm position sensor 75 may be a component position sensor. The at least one arm position sensor 75 may comprise a stick position sensor, for generating stick position data. The stick position sensor may be mounted to the stick 17. The at least one arm position sensor 75 may comprise a boom position sensor, for generating boom position data. The boom position sensor may be mounted to the boom 16.

The system 9 may comprise at least one sensor 7. The at least one sensor 7 may comprise one or more of a swing angle sensor 71, at least one movement or acceleration sensor 73, the at least one arm position sensor 75, a boom pressure sensor 77, an inertial measurement unit (IMU), an accelerometer, a gyroscope, a magnetometer, and a pressure sensor. In order to reduce complexity of the work vehicle 10, it may be beneficial to reduce the number of sensors necessary. For example, it may be beneficial for the work vehicle 10 to not include the swing angle sensor 71 if possible.

The controller 51 may be communicatively connected (via a wired or wireless connection) to the power unit, and any of the at least one system actuator 4 and/or at least one sensor 7 for providing control signals thereto and receiving sensor signals therefrom in order to control the operation of the work vehicle 10. The controller 51 may communicate with the input device 6, for receiving an input and controlling the work vehicle 10. The input device 6 may be in communication with the controller 51 for controlling the actuation of the swing actuator 30 and/or swing brake 34 to adjust the swing speed ω and/or adjust the swing angle θ of the swing apparatus 11. The input device 6 may increase or decrease the swing speed ω of the swing apparatus 11 relative to the swing base 13.

The controller 51 may receive operating condition data indicative of at least one operating condition of the work vehicle 10 by being communicatively coupled with the at least one sensor 7 and the at least one system actuator 4. The controller 51 may process the received operating condition data to determine further operating condition data and may store the operating condition data on the memory 53. The at least one operating condition and operating condition data may comprise at least one of:
The swing angle θ of the work vehicle 10, relative to the reference travel axis 43 (as shown in FIG. 2). The control system 50 may comprise a swing angle sensor 71 for determining the swing angle θ of the work vehicle 10;
The swing speed ω of the work vehicle 10. The control system 50 may comprise at least one movement or acceleration sensor 73 for determining the swing speed ω of the work vehicle 10;
The arm position of the work vehicle 10. The control system 50 may comprise the at least one arm position sensor 75 for determining the arm position of the work vehicle 10. The at least one arm position sensor 75 may be mounted to the swing apparatus 11. The at least one arm position sensor 75 may comprise at least one inertial measurement unit (IMU);
The boom position; stick position; and/or tool position of the work vehicle 10. The control system 50 may comprise at least one arm position sensor 75 attached to the boom 16; stick 17 and/or tool 15 for determining the boom 16; stick 17; and/or tool 15 position of the work vehicle 10. The at least one arm position sensor 75 may comprise at least one inertial measurement unit (IMU) attached to the boom 16; stick 17 and/or tool 15;
A component movement and/or acceleration of the work vehicle 10. The control system 50 may comprise at least one movement or acceleration sensor 73 for determining the component movement and/or acceleration of the work vehicle 10. The at least one movement or acceleration sensor 73 may be mounted to the swing apparatus 11. The at least one movement or acceleration sensor 73 may be at least one accelerometer;
A boom movement and/or acceleration; stick movement and/or acceleration; and/or tool movement and/or acceleration. The control system 50 may comprise at least one movement or acceleration sensor 73 attached to the boom 16; stick 17 and/or tool 15 for determining the boom 16; stick 17; and/or tool 15 movement and/or acceleration. The at least one movement or acceleration sensor 73 may comprise at least one accelerometer attached to the boom 16; stick 17 and/or tool 15;
The boom and/or stick angle of the work vehicle 10. The control system 50 may comprise the arm position sensor 75, such as the IMU for determining the boom and/or stick angle of the work vehicle 10;
The boom and/or stick hydraulic piston rod extension of the work vehicle 10. The control system 50 may comprise the arm position sensor 75, such as the IMU for determining the boom and/or stick hydraulic piston rod extension of the work vehicle 10;
A boom head end pressure of the work vehicle 10. The control system 50 may comprise the boom pressure sensor 77, within the boom hydraulic cylinder 18, for determining the boom head end pressure of the work vehicle 10;
The configuration of the work vehicle 10. The configuration of the work vehicle 10 may be input by an operator via the at least one input device 6; stored on the memory 53; and/or detected automatically using work vehicle sensors;
The brake torque τ_{b} of the swing brake 34 of the work vehicle 10. The brake torque τ_{b} may be input by an operator via at least one input device 6, stored on the memory 53 and/or estimated based upon a change in the component movement and/or acceleration upon application of the swing brake 34. The brake torque τ_{b} applied at any time may be based upon the input to the at least one input device 6. A 0% input to the at least one input device 6 may result in a maximum brake torque τ_{b,max} being applied by the swing brake 34;
An actuation torque τₐ of the swing actuator 30 of the work vehicle 10. The actuation torque τₐ may be input by an operator via at least one input device 6, stored on the memory 53 and/or estimated based upon a change in the component movement and/or acceleration upon application of the swing actuator 30. The actuation torque τₐ may be based upon the input to the at least one input device 6;
The maximum operational swing speed of the work vehicle. The maximum operational swing speed of the work vehicle may be determined according to the methods of this disclosure;
A maximum allowable swing speed ωₘₐₓ of the work vehicle. The maximum allowable swing speed ωₘₐₓ of the work vehicle may be determined according to the methods of this disclosure; and
The predetermined maximum angular stopping displacement θₛ. The predetermined maximum angular stopping displacement θₛ may be input by an operator via at least one input device 6 and/or stored on the memory 53. The predetermined maximum angular stopping displacement θₛ may be set by a regulatory and/or a safety requirement;

The operating condition data collected by the control system 50 may be transferred to the external computing system 61, which may perform the method of the present disclosure. Thus, the control system 50 may be considered in the present disclosure to comprise the external computing system 61, which may have instructions stored thereon for performing the methods disclosed herein in a similar manner to the controller 51.

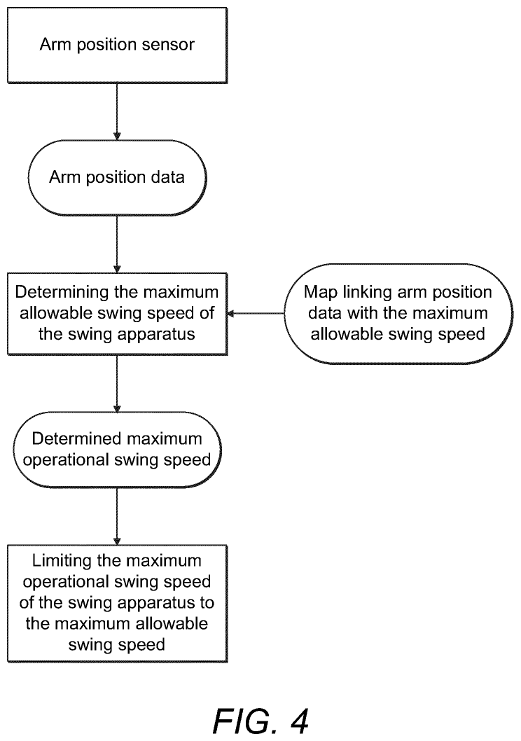

As shown in FIG. 4, a method of operating the work vehicle 10 comprises determining the maximum allowable swing speed ωₘₐₓ of the swing apparatus 11 rotating about the swing axis 33 to account for the moment of inertia J of the swing apparatus 11 and limiting the maximum operational swing speed of the swing apparatus 11 to the maximum allowable swing speed ωₘₐₓ. The maximum allowable swing speed ωₘₐₓ is determined based on arm position data, and a map linking arm position data with the maximum allowable swing speed ωₘₐₓ. The method is performed by the control system 50.

The arm position data may be used to account for the moment of inertia J of the swing apparatus 11. An extension of the arm arrangement 14 affects the moment of inertia J as explained above. In accordance with the present disclosure, arm position data may be an indication of the moment of inertia J. Basing the maximum allowable swing speed ωₘₐₓ on arm position data can allow the moment of inertia J to be accounted for when determining the maximum allowable swing speed ωₘₐₓ.

The map linking arm position data with the maximum allowable swing speed ωmax may be a look up table, an algorithm, a function, an equation or any other suitable map for determining the maximum allowable swing speed ωₘₐₓ based on the arm position data. The map may be a simulation, computational model and/or digital twin of the work vehicle 10. The control system 50 may input the arm position data into the simulation, computational model and/or digital twin and use this to calculate and/or model at least one operating condition and/or maximum allowable swing speed ωₘₐₓ of the work vehicle 10. The map may be prepared via experimentation and empirical methods to find the appropriate maximum allowable swing speed ωₘₐₓ for given arm position data.

The extension of the arm arrangement 14 may be monitored using the stick angle 41 and/or boom angle 39, and/or cylinder extension data of the stick and/or boom hydraulic actuator. As the stick angle 41 and/or boom angle 39 are adjusted, the moment of inertia J will be affected because the position of the arm arrangement 14 will change. The stick angle 41 and/or boom angle 39 may be used by the control system 50 as direct inputs in determining the maximum allowable swing speed ωₘₐₓ.

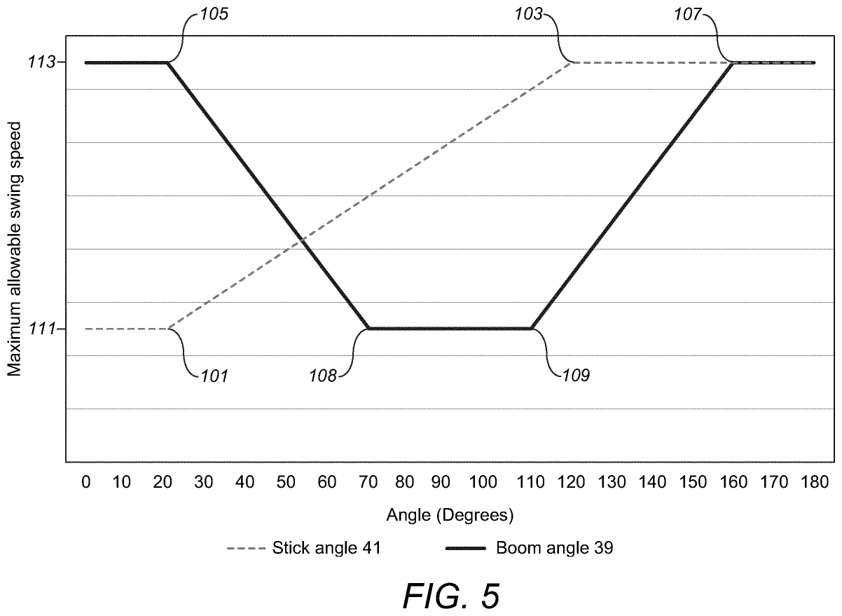

FIG. 5 illustrates how the arm position data may be, in the map, used to determine the maximum allowable swing speed ωₘₐₓ. As shown in FIG. 5, the arm position data may comprise stick and/or boom angle data. The arm position data may comprise cylinder extension data of the stick and/or boom hydraulic actuator. FIG. 5 illustrates how the maximum allowable swing speed ωₘₐₓ may vary with stick angle 41 and/or boom angle 39.

As shown in FIG. 5, as the stick angle 41 increases, the maximum allowable swing speed ωₘₐₓ may increase. The stick angle 41 increasing may cause the extension of the arm arrangement 14 of the work vehicle 10 to reduce and/or a distance of the tool 15 from the swing axis 33 to reduce. This reduction may cause the moment of inertia J to reduce. A higher maximum allowable swing speed ωₘₐₓ may still allow the swing apparatus 11 to slow to zero within the predetermined maximum angular stopping displacement θₛ due to the reduced moment of inertia J. The maximum allowable swing speed ωₘₐₓ may be increased accordingly.

Below a first stick angle 101, the maximum allowable swing speed ωₘₐₓ may be at a lower limit 111 below which it is not decreased. Above a second stick angle 103, the maximum allowable swing speed ωₘₐₓ may be at an upper limit 113 beyond which it is not increased. The stick angles 41 at which the maximum allowable swing speed ωₘₐₓ starts to increase 101, stops increasing 103, and the rate of increase may be selected via experimentation and empirical methods to find the appropriate maximum allowable swing speed ωₘₐₓ for a given stick angle 41.

As also shown in FIG. 5, as the boom angle 39 increases, the maximum allowable swing speed ωₘₐₓ may decrease, then remain constant and then increase. The boom angle 39 increasing from small angles may cause the extension of the arm arrangement 14 of the work vehicle 10 to increase and/or a distance of the tool 15 from the swing axis 33 to increase. This increase may cause the moment of inertia J to increase. A lower maximum allowable swing speed ωₘₐₓ may be required to allow the swing apparatus 11 to slow to zero within the predetermined maximum angular stopping displacement θₛ. The maximum allowable swing speed ωₘₐₓ may be decreased accordingly.

The boom angle 39 increasing at angles of around 70 to 110 degrees may not affect the extension of the arm arrangement 14 of the work vehicle 10 and/or a distance of the tool 15 from the swing axis 33. This may cause the moment of inertia J to remain roughly constant. A constant maximum allowable swing speed ωₘₐₓ may allow the swing apparatus 11 to slow to zero within the predetermined maximum angular stopping displacement θₛ. The maximum allowable swing speed ωₘₐₓ may be kept constant accordingly. The boom angle 39 increasing from angles of around 110 degrees may cause the extension of the arm arrangement 14 of the work vehicle 10 to decrease and/or a distance of the tool 15 from the swing axis 33 to decrease. This increase may cause the moment of inertia J to decrease. A higher maximum allowable swing speed ωₘₐₓ may still allow the swing apparatus 11 can slow to zero within the predetermined maximum angular stopping displacement θₛ. The maximum allowable swing speed ωₘₐₓ may be increased accordingly.

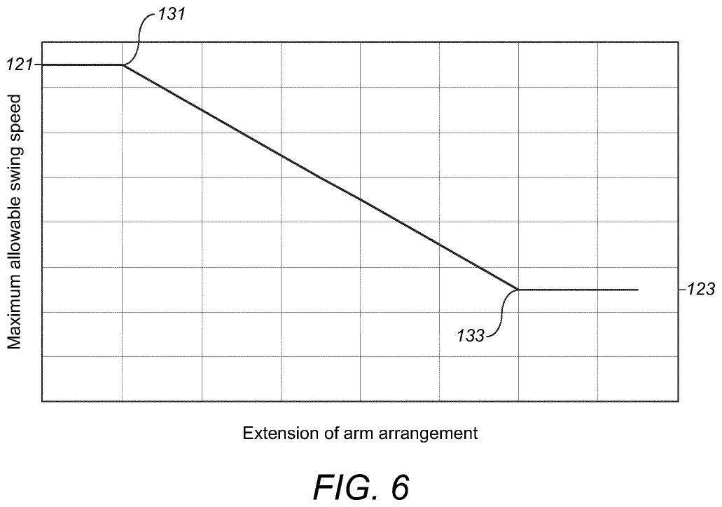

Below a first boom angle 105, and above a second boom angle 107, the maximum allowable swing speed ωₘₐₓ may be at the upper limit 113 beyond which it is not increased. Between a third and fourth boom angle 108, 109 the maximum allowable swing speed ωₘₐₓ may be at the lower limit 111 below which it is not decreased. The boom angles 39 at which the maximum allowable swing speed ωₘₐₓ starts to decrease 105, stops decreasing 108, starts to increase 109, stops increasing 107, and the rate of decrease and increase may be selected via experimentation and empirical methods to find the appropriate maximum allowable swing speed ωₘₐₓ for a given boom angle 39. The arm position data may comprise boom position data and stick position data. The boom position data and stick position data may be combined together. The arm position data may be indicative of an extension of the arm arrangement 14 of the swing apparatus 11. As shown in FIG. 6, the maximum allowable swing speed ωₘₐₓ may decrease as the extension of the arm arrangement 14 increases. The maximum allowable swing speed ωₘₐₓ may be a first maximum allowable swing speed 121 when the extension of the arm arrangement 14 is a first extension 131. The maximum allowable swing speed ωₘₐₓ may be a second maximum allowable swing speed 123 when the extension of the arm arrangement 14 is a second extension 133. The first maximum allowable swing speed 121 may be higher than the second maximum allowable swing speed 123 and the second extension 133 may be greater than the first extension 131.

The maximum allowable swing speed ωₘₐₓ may be equal to the first maximum allowable swing speed 121 when the extension of the arm arrangement 14 is less than the first extension 131. The first maximum allowable swing speed 121 may be input by an operator via at least one input device 6 and/or stored on the memory 53. The first maximum allowable swing speed 121 may be set by safety considerations and/or vehicle limits. The first maximum allowable swing speed 121 may be equal to the upper limit 113 described above in reference to FIG. 5. By setting the maximum allowable swing speed ωₘₐₓ equal to the first maximum allowable swing speed 121 when the extension of the arm arrangement 14 is below the first extension 131, configurations having a low moment of inertia J (which correspond to an extension below the first extension 131) will have improved performance as the maximum allowable swing speed ωₘₐₓ is higher.

The maximum allowable swing speed ωₘₐₓ may be equal to the second maximum allowable swing speed 123 when the extension of the arm arrangement 14 is more than the second extension 133. The second maximum allowable swing speed 123 may be based upon the predetermined maximum angular stopping displacement θₛ and a rate of deceleration of the swing apparatus in the configuration having the greatest inertia. The second maximum allowable swing speed 123 may be the swing speed ω from which the swing apparatus 11 can slow to zero given the rate of deceleration of the swing apparatus in the configuration having the greatest inertia. The second maximum allowable swing speed 123 may be equal to the lower limit 111 described above in reference to FIG. 5. A limit of the second maximum allowable swing speed 123 may ensure that the work vehicle 10 can stop within a safe distance when in the greatest inertia configuration. By setting the maximum allowable swing speed ωₘₐₓ equal to the second maximum allowable swing speed 123 when the extension is above the second extension 133, configurations having a high moment of inertia J (which correspond to an extension above the second extension 133) will be able to stop within a safe distance.

The method may further comprise, by the control system 50, changing an arm position of the work vehicle 10 and/or causing the arm position to change. The maximum allowable swing speed ωₘₐₓ may be updated based on new arm position data and the map linking arm position data with the maximum allowable swing speed. The maximum operational swing speed of the swing apparatus 11 may be limited to the updated maximum allowable swing speed.

The method may comprise updating the maximum allowable swing speed ωₘₐₓ at a certain time interval. The maximum allowable swing speed ωₘₐₓ may be updated every 0.1 seconds, every 1 second, or every 10 seconds. The maximum allowable swing speed ωₘₐₓ may be redetermined after an input is received by the controller 51. The maximum allowable swing speed ωₘₐₓ may be dynamically redetermined and/or updated.

The method may further comprise the control system 50 rotating the swing apparatus 11 about the swing axis 33 at a swing speed ω equal to or less than the maximum operational swing speed. The method may further comprise the control system 50 overriding a user command to rotate the swing apparatus 11 around the swing axis 33 at a swing speed ω greater than the maximum operational swing speed. Overriding the user command may comprise receiving a user input to perform a rotation at a swing speed ω greater than the maximum operational swing speed and outputting a command to the swing actuator 30 to perform a rotation at a swing speed ω equal to or less than the maximum operational swing speed.

### INDUSTRIAL APPLICABILITY

The method 50 may thus use the arm position data to determine an appropriate maximum allowable swing speed ωₘₐₓ. By using the arm position data of the present arm position of the work vehicle 10, an appropriate maximum allowable swing speed @ₘₐₓ for this specific arm position is determined. Overly limiting the swing speed ω due to a higher moment of inertia J of other arm positions does not occur. The maximum allowable swing speed ωₘₐₓ is therefore based on the current arm position and so may be maximised. This ensures that the work vehicle 10 is able to reduce its swing speed ω to zero in a safe distance, such as the predetermined maximum angular stopping displacement θₛ, across different arm positions of the work vehicle 10.

In addition, the swing performance of the work vehicle 11 is not unduly affected as it is always at a maximum safe speed for the current arm position. This is accomplished with only the at least one arm position sensor 75 and so the number of sensors on the work vehicle 10 can be minimized.

1. A method of operating a work vehicle comprising:
a swing apparatus rotatable about a swing axis, the swing apparatus comprising an arm arrangement comprising a stick and a boom, and
at least one arm position sensor mounted to the swing apparatus for generating arm position data indicative of a position of the stick and/or the boom,
the method comprising, by a control system:
determining a maximum allowable swing speed of the swing apparatus rotating about the swing axis, to account for the moment of inertia of the swing apparatus, based on:
arm position data, and
a map linking arm position data with the maximum allowable swing speed; and
limiting a maximum operational swing speed of the swing apparatus to the maximum allowable swing speed.

2. The method of claim 1, wherein the at least one arm position sensor comprises a stick position sensor, and the arm position data comprises stick position data.

3. The method of claim 1, wherein the at least one arm position sensor comprises a boom position sensor, and the arm position data comprises boom position data.

4. The method of claim 1, wherein the arm position data is indicative of an extension of the arm arrangement of the swing apparatus.

5. The method of claim 4, wherein the maximum allowable swing speed is a first maximum allowable swing speed ωhen the extension of the arm arrangement is a first extension, and the maximum allowable swing speed is a second maximum allowable swing speed ωhen the extension of the arm arrangement is a second extension, wherein the first maximum allowable swing speed is higher than the second maximum allowable swing speed and the second extension is larger than the first extension.

6. The method of claim 5, wherein the maximum allowable swing speed is equal to the first maximum allowable swing speed ωhen the extension of the arm arrangement is less than the first extension.

7. The method of claim 5, wherein the maximum allowable swing speed is equal to the second maximum allowable swing speed ωhen the extension of the arm arrangement is more than the second extension.

8. The method of claim 7, wherein the work vehicle is configurable in a plurality of different configurations of differing inertias, and the second maximum allowable swing speed is based upon a predetermined maximum angular stopping displacement and a rate of deceleration of the swing apparatus in the configuration having the greatest inertia.

9. The method of claim 1, wherein the arm position data comprises stick and/or boom angle data.

10. The method of claim 1, wherein the work vehicle further comprises a stick and/or boom hydraulic actuator, and the arm position data comprises cylinder extension data of the stick and/or boom hydraulic actuator.

11. The method of claim 1, wherein the method further comprises, by the control system:
changing an arm position of the work vehicle;
updating the maximum allowable swing speed of the swing apparatus based on:
new arm position data, and
the map linking arm position data with the maximum allowable swing speed; and
limiting the maximum operational swing speed of the swing apparatus to the updated maximum allowable swing speed.

12. The method of claim 1, wherein the method further comprises, by the control system:
rotating the swing apparatus about the swing axis at a swing speed equal to or less than the maximum operational swing speed; and/or
overriding a user command to rotate the swing apparatus around the swing axis at a swing speed greater than the maximum operational swing speed.

13. A controller for controlling a work vehicle comprising:
a swing apparatus rotatable about a swing axis, the swing apparatus comprising an arm arrangement comprising a stick and a boom, and
at least one arm position sensor mounted to the swing apparatus for generating arm position data indicative of a position of the stick and/or the boom,
the controller being configured to:
determine a maximum allowable swing speed of the swing apparatus rotating about the swing axis, to account for the moment of inertia of the swing apparatus, based on:
arm position data, and
a map linking arm position data with the maximum allowable swing speed; and
limit a maximum operational swing speed of the swing apparatus to the maximum allowable swing speed.

14. A work vehicle comprising:
a swing apparatus rotatable about a swing axis, the swing apparatus comprising an arm arrangement comprising a stick and a boom,
at least one arm position sensor mounted to the swing apparatus for generating arm position data indicative of a position of the stick and/or the boom, and
a control system comprising the controller of claim 13.
